(19) United States
(12) Patent Application Publication
(10) Pub. No.: US 2019/0355281 A1
(43) Pub. Date: Nov. 21, 2019

(54) LEARNING SUPPORT SYSTEM AND RECORDING MEDIUM

(71) Applicant: Mitutoyo Corporation, Kawasaki (JP)

(72) Inventor: Shinsaku Abe, Iwamizawa (JP)

(21) Appl. No.: 16/407,549

(22) Filed: May 9, 2019

(30) Foreign Application Priority Data
May 15, 2018 (JP) 2018-093625

(51) Int. Cl. G09B 25/02; G09B 5/02; H04N 13/344; G02B 27/01; G06T 13/40

(52) U.S. Cl. CPC G09B 25/02; G09B 5/02; G06T 13/40; G02B 27/017; H04N 13/344

(57) ABSTRACT

A learning support system of the present invention is a learning support system that supports learning of work using a real measuring machine for measuring a measurement object, including a position and attitude recognition unit that recognizes a position and/or an attitude of an object within a real three-dimensional space; a storage unit that stores learning data that defines exemplary work performed by an avatar using a virtual measuring machine within a virtual three-dimensional space; a stereoscopic video generation unit that generates a three-dimensional video of the exemplary work performed by the avatar, based on the position and/or the attitude of the object recognized by the position and attitude recognition unit, as well as the learning data stored in the storage unit; and a head-mounted display that is mounted on a learner's head, and displays the three-dimensional video so as to be superimposed on the real three-dimensional space.

### CROSS-REFERENCE TO RELATED APPLICATION

This non-provisional application claims priority under 35 U.S.C. § 119(a) from Japanese Patent Application No. 2018-93625, filed on May 15, 2018, the entire contents of which are incorporated herein by reference.

### BACKGROUND

### Technical Field

The present invention relates to a learning support system and a program which support learning of equipment operations or work procedures.

### Background Art

Various methods have been conventionally adopted as methods of learning equipment operation methods or the work procedures, such as learning through a classroom lecture in a course or the like, learning under direct instruction from an expert, such as OJT (on-the-job training) and one-to-one training, learning through a procedure document or a textbook, and learning through a training video. Support systems have also been proposed for work management or work learning for work using an apparatus, based on a level of an individual worker (for example, see Japanese Patent Laid-Open No. 2016-092047).

### SUMMARY OF THE INVENTION

### Problems to be Solved by the Invention

Unfortunately, the above described learning methods have problems, respectively, as described below.

For example, while the OJT is a method that can convert a beginner's unsuccessful experiences into his/her accumulation of knowledge and technical capabilities, the OJT has the problems as follows. A learner often worries about inability to catch up with work content. Heavy temporal and psychological burdens are imposed on an instructor. Effects of the OJT greatly depend on the instructor's instruction ability (such as the instructor's quality, capabilities and behavior). The instructor must learn an instruction method. The beginner is often difficult to obtain a basic understanding of the learning or falls short thereof.

Moreover, while the one-to-one training is ideal for the learner, it also has the problems as follows, in addition to the problems similar to those of the OJT. The one-to-one training inefficiently binds the instructor to repetitive training. Changes in the work procedures lead to low reduction in training costs.

Under instruction through a document, such as the procedure document or the textbook, the learner can perform self-education. Such instruction, however, has the problems as follows. The learner's level of understanding depends on quality of the document. A document suitable for the learner's level is required. Creation of the document takes a considerable time. The learner must imagine situations of actual practice of learned content. A knack or know-how is not transferred due to its difficult expression in words.

While the training video also enables the self-education similarly to the document, it has the problems as follows. The learner often cannot view and understand a desired portion. It is difficult for the learner to memorize a procedure while viewing the video, and thus the video is not so useful when the learner tries by himself. Operations are also cumbersome, such as stopping the video for each procedure that the learner has to memorize, and playing the same portion. The learner needs to frequently and inefficiently change his viewpoint between the work content in front of him and the video.

In this way, there has not yet been an instruction method realized to reduce a binding time of the instructor as much as possible, and enable the learner to repeatedly acquire technologies through high-quality self-education.

An object of the present invention is to provide a learning support system and a program suitable thereto which suppress the binding time of the instructor and enable the learner to repeatedly acquire the technologies through the high-quality self-education.

### Means for Solving the Problems

In order to solve the above described problems, a learning support system according to an embodiment of the present invention is a learning support system that supports learning of work using a real measuring machine for measuring a measurement object, including a position and attitude recognition unit that recognizes a position and/or an attitude of an object within a real three-dimensional space; a storage unit that stores learning data that defines exemplary work performed by an avatar using a virtual measuring machine within a virtual three-dimensional space; a stereoscopic video generation unit that generates a three-dimensional video of the exemplary work performed by the avatar, based on the position and/or the attitude of the object recognized by the position and attitude recognition unit, as well as the learning data stored in the storage unit; and a head-mounted display that is mounted on a learner's head, and displays the three-dimensional video so as to be superimposed on the real three-dimensional space. In this way, the learner can repeatedly observe an appearance of the exemplary work replicated by the avatar, from various angles.

In the present invention, the position and attitude recognition unit may recognize the position and/or the attitude of the object within the real three-dimensional space, based on output from a three-dimensional sensor that detects three-dimensional coordinates of the object in the real three-dimensional space, and/or from a head sensor that is included in the head-mounted display and senses a position and/or an attitude of the head-mounted display. In this way, a position and/or an attitude of the real measuring machine or the learner in the real three-dimensional space can be recognized.

In the present invention, the stereoscopic video generation unit may recognize a correspondence relationship between a coordinate system in the real three-dimensional space and a coordinate system in the virtual three-dimensional space, and generate three-dimensional video data so that a visual field moves within the virtual three-dimensional space in accordance with movement of the head-mounted display in the real three-dimensional space. In this way, the learner can observe the exemplary work from free viewpoints during actual movement, without any complicated operation.

In the present invention, the stereoscopic video generation unit may place the avatar at position coordinates within the virtual three-dimensional space corresponding to position coordinates where the head-mounted display exists in the real three-dimensional space; place the virtual measuring machine at position coordinates within the virtual three-dimensional space corresponding to position coordinates where the real measuring machine is placed in the real three-dimensional space; grasp progress of the work performed by the learner, based on the learning data, as well as a position and an attitude of the learner and/or the real measuring machine outputted by the position and attitude recognition unit; and generate the three-dimensional video data of the exemplary work so as to precede the learner's work by a predetermined time, based on the grasped progress of the work and the learning data. In this way, a motion of the avatar is automatically adjusted in accordance with a working speed of the learner. The learner can perform the work, following the avatar's operations, and thereby mimic an expert's work to practice the work.

In the present invention, the stereoscopic video generation unit may calculate a delay time of the grasped progress of the work from the exemplary work, and notify the learner of the delay time. In this way, the learner can easily grasp his/her own proficiency in comparison with the expert. Moreover, the learner can grasp a process that the learner is not good at, recognize a difference from a target working time, and also try to shorten a measurement time.

In the present invention, the stereoscopic video generation unit may generate the three-dimensional video data so that the visual field moves within the virtual three-dimensional space in response to an operation without movement of the learner within the real three-dimensional space. In this way, the learner can observe the exemplary work from free positions within the virtual three-dimensional space, without any actual movement.

In the present invention, the head-mounted display may include a transmissive display.

A program according to the embodiment of the present invention causes a computer to function as any of the above described learning support systems.

### BRIEF DESCRIPTION OF THE DRAWINGS

FIG. 1 is a schematic diagram showing a configuration of a learning support system 1 with a learner L and a real measuring machine RM;

FIG. 2 is a block diagram showing a configuration of a computer 100;

FIG. 3 is a block diagram showing a configuration of a head-mounted display 200;

FIG. 4 is a schematic diagram showing a relationship between the learner L and an avatar AV with a virtual measuring machine AM in a first learning mode; and

FIG. 5 is a schematic diagram showing the relationship between the learner L and the avatar AV with the virtual measuring machine AM in a second learning mode.

### DETAILED DESCRIPTION OF THE EMBODIMENTS

A learning support system 1 according to an embodiment of the present invention will be described below based on the drawings. It should be noted that the same member is given the same reference number, and descriptions of members described once will be omitted as appropriate in the following description.

### (Configuration of Learning Support System 1)

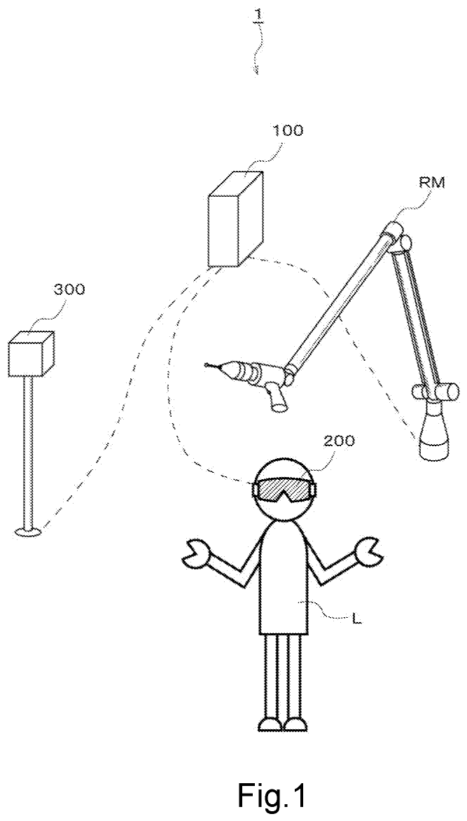

FIG. 1 is a schematic diagram showing a configuration of the learning support system 1 with a learner L and a real measuring machine RM that is a real machine of a measuring machine whose operation method is to be learned (hereinafter referred to as “real measuring machine”). In the present embodiment, the real measuring machine RM is an apparatus that measures three-dimensional coordinates, a length at a predetermined position or the like of a measurement object. The real measuring machine RM includes, for example, a three-dimensional position measuring machine and an image measuring machine. As shown in FIG. 1, the learning support system 1 includes a computer 100, a head-mounted display 200, and a 3D sensor 300.

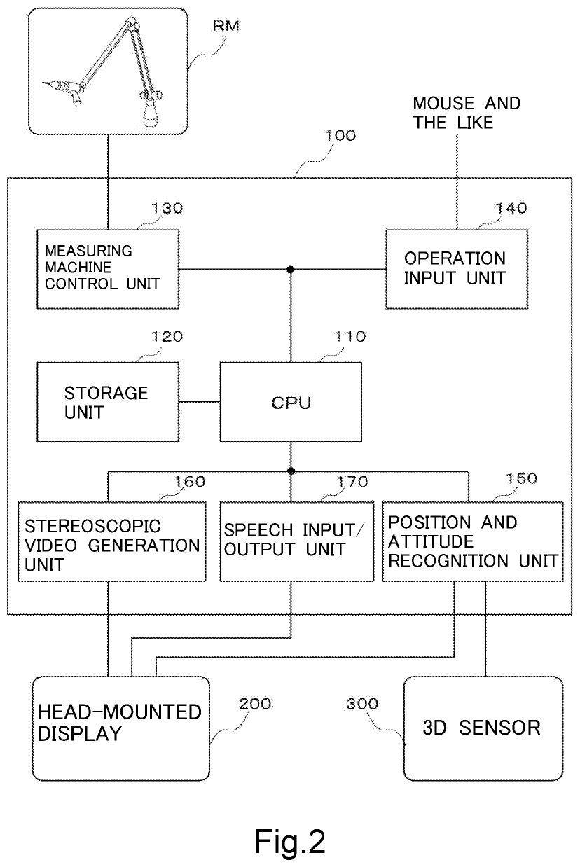

FIG. 2 is a functional block diagram of the computer 100. The computer 100 has a CPU (Central Processing Unit) 110, a storage unit 120, a measuring machine control unit 130, an operation input unit 140, and a position and attitude recognition unit 150. The computer 100 further has a stereoscopic video generation unit 160, and a speech input/output unit 170. The head-mounted display 200, the 3D sensor 300, and the real measuring machine RM are connected to the computer 100.

The CPU 110 executes a predetermined program to thereby control each unit or perform a predetermined operation. The storage unit 120 includes a main storage unit and a sub-storage unit. The storage unit stores programs to be executed in each unit of the computer 100 including the CPU 110, and various data to be used in each unit. In the learning support system 1 of the present embodiment, the storage unit 120 stores learning data of work procedures or the like to be learned.

The learning data is, for example, data associated with a shape, an attitude, a motion, a position, a speech and the like of a virtual measuring machine AM or a virtual human model (avatar) AV. A three-dimensional video, a speech and the like to be played for leaning are based on the learning data. In other words, the learning data defines exemplary work performed by the avatar AV using the virtual measuring machine AM within a virtual three-dimensional space. CAD data may be used as the shape of the virtual measuring machine AM included in such learning data, for example. Moreover, three-dimensional shape data of the learner L himself or various characters may be used as the shape of the avatar AV. Data representing the attitude or the motion of the virtual measuring machine AM or the avatar AV may be created through motion capture of an expert's work. Alternatively, model data may be constructed from information on the work procedures or the like. Moreover, the speech may be a recorded real voice of a human (the expert, a narrator or the like), or a synthetic speech may be data to be played.

The measuring machine control unit 130 is configured to be able to control the real measuring machine RM, or obtain a status or a measured value of the real measuring machine RM, based on a user's direction or the program stored in the storage unit 120. The operation input unit 140 accepts operation input from input devices (not shown), such as a keyboard, a mouse, and a touch panel.

The speech input/output unit 170 receives a speech input signal from a microphone 230 included in the head-mounted display 200, and also outputs a speech output signal to a speaker 240 included in the head-mounted display 200.

The position and attitude recognition unit 150 captures information obtained by the 3D sensor 300, a position or an orientation of the head-mounted display 200 detected by a head sensor 220 of the head-mounted display 200, a surrounding environment of the head-mounted display 200 and the like into the computer 100, and based on them, recognizes a position (three-dimensional coordinates) or an attitude of an object (the learner L, the real measuring machine RM or the like) within a real three-dimensional space. Here, the 3D sensor 300 is a sensor that detects the three-dimensional coordinates of the objects (for example, the real measuring machine RM and the learner L) in the real three-dimensional space, and is placed around the real measuring machine RM.

The stereoscopic video generation unit 160 generates data of the three-dimensional video including the virtual measuring machine AM and the avatar AV placed within the virtual three-dimensional space, based on the learning data stored in the storage unit 120, an input operation accepted by the operation input unit 140, a speech inputted into the microphone 230 of the head-mounted display 200, and the position or the attitude of the object recognized by the position and attitude recognition unit 150. The three-dimensional video is displayed on a display unit of the head-mounted display 200, based on the generated three-dimensional video data.

The stereoscopic video generation unit 160 recognizes a correspondence relationship between a coordinate system in the real three-dimensional space and a coordinate system in the virtual three-dimensional space, and utilizes the correspondence relationship to generate the three-dimensional video. Specifically, the stereoscopic video generation unit 160 generates the three-dimensional video data so that when the learner L wearing the head-mounted display 200 moves in the real three-dimensional space, a visual field moves within the virtual three-dimensional space in accordance with the movement of the learner L wearing the head-mounted display 200 within the real three-dimensional space (follow-up display). In this way, the exemplary work can be observed from various angles without any complicated operation.

The correspondence relationship between the coordinate system in the real three-dimensional space and the coordinate system in the virtual three-dimensional space may be preset, or set based on the position or the attitude of the object recognized by the position and attitude recognition unit 150. If the correspondence relationship between the coordinate system in the real three-dimensional space and the coordinate system in the virtual three-dimensional space is set based on the position or the attitude of the object recognized by the position and attitude recognition unit 150, the coordinate systems are adjusted so that the virtual measuring machine AM is placed in the virtual three-dimensional space, in accordance with a placement position of the real measuring machine RM.

Moreover, the stereoscopic video generation unit 160 generates the three-dimensional video data so that the visual field moves within the virtual three-dimensional space in response to a gesture or an operation of the input device performed by the learner L, without the movement of the learner L within the real three-dimensional space (non-follow-up display). In the above described follow-up display with the movement within the virtual three-dimensional space in accordance with the movement within the real three-dimensional space, the exemplary work can be observed only from positions where physical movement is allowed. In contrast, in the non-follow-up display, the exemplary work can be observed from free positions within the virtual three-dimensional space. For example, the exemplary work can be observed from a higher perspective in the air.

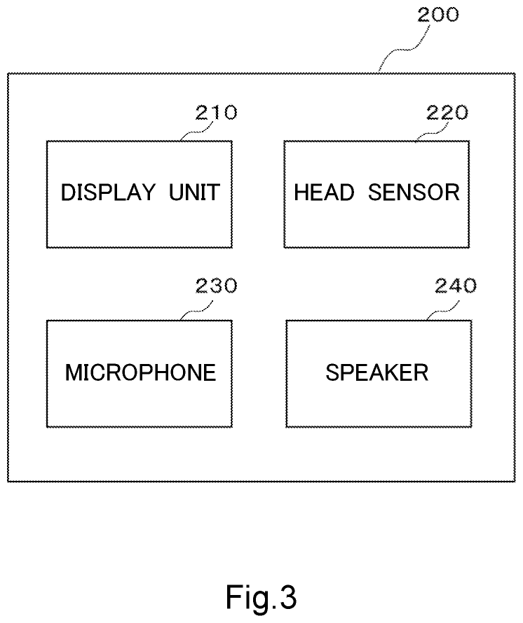

FIG. 3 is a block diagram showing a configuration of the head-mounted display 200. The head-mounted display 200 is a device that is mounted on the learner L's head, and includes a display unit 210, the head sensor 220, the microphone 230, and the speaker 240.

The display unit 210 includes two transmissive displays. These two displays correspond to the right eye and the left eye, respectively. The display unit 210 displays the three-dimensional video generated based on the learning data and the like by the stereoscopic video generation unit 160 included in the computer 100. Since the displays are transmissive, the learner L can visually recognize the surrounding environment in a real space through the display unit 210. Accordingly, the three-dimensional video displayed by the display unit 210 is displayed so as to be superimposed on the surrounding environment in the real space.

The microphone 230 picks up a speech uttered by the learner L, converts the speech into the speech input signal, and provides the speech input signal to the speech input/output unit 170. The microphone 230 is placed so as to be positioned near the mouth of the learner L for easy pickup of a voice uttered by the learner L, in a state where the head-mounted display 200 is mounted on the learner's head. A relatively highly directional microphone may be used as the microphone 230.

The speaker 240 outputs the speech based on the speech output signal outputted from the speech input/output unit 170 based on the learning data. The speaker 240 may be placed so as to come into contact with the learner L's ear, in the state where the head-mounted display 200 is mounted on the learner's head. It should be noted that the microphone 230 and/or the speaker 240 may also be provided separately from the head-mounted display 200.

The head sensor 220 senses a position or an attitude of the head-mounted display 200 (that is, a position or an orientation of the head of the learner L wearing the head-mounted display 200), an environment where the head-mounted display 200 is placed, and the like. As the head sensor 220, for example, an acceleration sensor, a gyro sensor, a direction sensor, a depth sensor, a camera or the like may be used. Output of the head sensor 220 is inputted to the position and attitude recognition unit 150.

### (Example of Using Learning Support System)

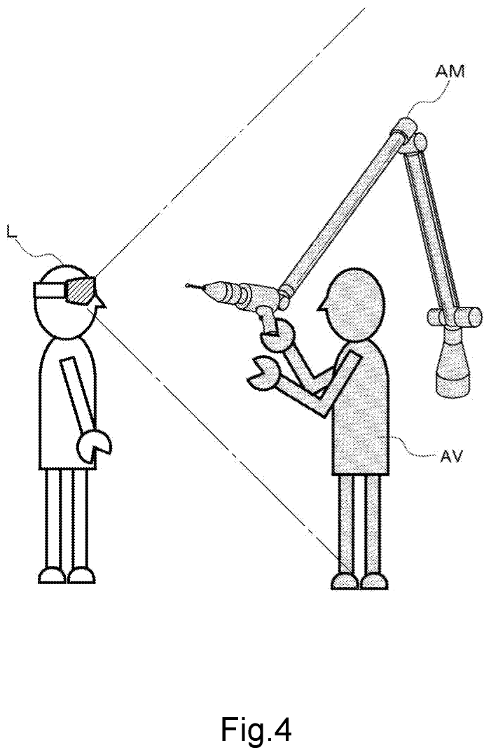

An example of using the learning support system 1 configured as described above will be described next. For learning using the learning support system 1, the learner L wears the head-mounted display 200, as shown in FIG. 4. On the display unit 210 of the head-mounted display 200, the virtual measuring machine AM and the avatar AV are displayed within the virtual three-dimensional space, based on the three-dimensional video data generated by the stereoscopic video generation unit 160. Moreover, the speech is outputted from the speaker 240 in accordance with progress of the exemplary work played as the three-dimensional video.

The learning support system 1 in the present embodiment includes two learning modes as will be described below.

### (First Learning Mode)

A first learning mode is a mode for the learner L wearing the head-mounted display 200 to view and learn the exemplary work performed by the avatar AV operating the virtual measuring machine AM within a virtual space. FIG. 4 is a schematic diagram showing a relationship between the learner L and the avatar AV with the virtual measuring machine AM in the first learning mode.

With an input operation to play the learning data in the first learning mode, through the gesture or the input device, an appearance of the exemplary work is displayed as the three-dimensional video on the display unit 210 in the first learning mode, and the speech is outputted from the speaker 240 in accordance with the video.

In other words, the stereoscopic video generation unit 160 generates the three-dimensional video regarding the appearance of the work performed by the avatar AV using the virtual measuring machine AM, within the virtual three-dimensional space, based on the learning data stored in the storage unit 120. The stereoscopic video generation unit 160 then identifies the position and the attitude (an eye gaze position and the orientation) of the learner L within the virtual three-dimensional space, based on the position or the attitude of the learner L detected by the head sensor 220 or the 3D sensor 300; the relationship between the coordinate system in the real three-dimensional space and the coordinate system in the virtual three-dimensional space; and the like. The stereoscopic video generation unit 160 then generates the three-dimensional video of the appearance of the exemplary work as viewed at this position and this attitude.

The learner L can give orders to stop, repeat, slow down, rewind and the like, through the gesture or the operation of the input device. The stereoscopic video generation unit 160 receives these orders through the operation input unit 140 or the position and attitude recognition unit 150, and reflects the orders in the three-dimensional video data to be subsequently generated. Since such operations are enabled, the learner L can repeat or slowly move the exemplary work to freely observe the exemplary work.

The first learning mode enables both the follow-up display that displays the three-dimensional video so that the visual field moves within the virtual three-dimensional space in accordance with the movement of the learner L wearing the head-mounted display 200 in the real three-dimensional space; and the non-follow-up display that displays the three-dimensional video so that the visual field moves within the virtual three-dimensional space in response to the gesture or the operation of the input device performed by the learner L, without the movement of the learner L within the real three-dimensional space. The follow-up display and the non-follow-up display are configured to be switchable through the gesture or the operation of the input device. The follow-up display enables the observation from free viewpoints during actual movement, without any complicated operation. Moreover, the non-follow-up display enables the observation of the exemplary work from the free positions within the virtual three-dimensional space. In the non-follow-up display, for example, the exemplary work can also be observed from the higher perspective in the air.

In the first learning mode, the learner can repeatedly view the appearance of the expert's exemplary work replicated by the avatar AV within the virtual space, any number of times. The learner L can then move to observe the appearance of the exemplary work from the various angles, or can slow down a playback speed or pause and contemplate the appearance of the exemplary work. The learner L can thereby observe the exemplary work, either generally or in detail, from the various angles and perspectives. As a result, the learner can be expected to rapidly master the work. Moreover, the learner can view a knack or know-how of the work for each measurement operation, listen to messages, and thus easily understand essentials of the work. Accordingly, efficient learning support is enabled.

### (Second Learning Mode)

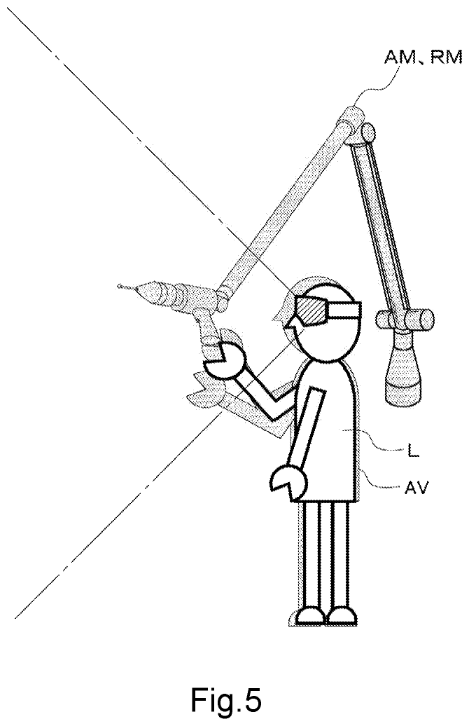

A second learning mode is a mode for the learner L to learn by operating the real measuring machine RM, following the exemplary work performed by the avatar AV operating the virtual measuring machine AM within the virtual space. FIG. 5 is a schematic diagram showing the relationship between the learner L and the avatar AV with the virtual measuring machine AM in the second learning mode. It should be noted that, in FIG. 5, the virtual measuring machine AM is displayed so as to overlap the real measuring machine RM.

With an input operation to play the learning data in the second learning mode, through the gesture or the input device, the appearance of the exemplary work is displayed as the three-dimensional video on the display unit 210 in the second learning mode, and the speech is outputted from the speaker 240 in accordance with the video.

In other words, the stereoscopic video generation unit 160 generates the three-dimensional video regarding the appearance of the work performed by the avatar AV using the virtual measuring machine AM, within the virtual three-dimensional space, based on the learning data stored in the storage unit 120. The stereoscopic video generation unit 160 then identifies the position and the attitude (the eye gaze position and the orientation) of the learner L within the virtual three-dimensional space, based on the position or the attitude of the learner L detected by the head sensor 220 or the 3D sensor 300; the relationship between the coordinate system in the real three-dimensional space and the coordinate system in the virtual three-dimensional space; and the like. The stereoscopic video generation unit 160 then generates the three-dimensional video of the appearance of the exemplary work as viewed at this position and this attitude.

In the second learning mode, the avatar AV is displayed so as to overlap the learner L within the virtual three-dimensional space. In other words, the avatar AV is placed at position coordinates within the virtual three-dimensional space corresponding to the position of the head-mounted display 200 (that is, position coordinates where the learner L exists) in the real three-dimensional space. Moreover, the virtual measuring machine AM is displayed so as to overlap the real measuring machine RM within the virtual three-dimensional space. In other words, the virtual measuring machine AM is placed at position coordinates within the virtual three-dimensional space corresponding to position coordinates where the real measuring machine RM is placed in the real three-dimensional space. The second learning mode uses the follow-up display that displays the three-dimensional video so that the visual field moves within the virtual three-dimensional space in accordance with the movement of the learner L wearing the head-mounted display 200 in the real three-dimensional space.

After the learning data is started to play, the stereoscopic video generation unit 160 continually contrasts the learning data being played, with the position and the attitude of the learner L or the real measuring machine RM outputted by the position and attitude recognition unit 150, and thereby grasps progress of the work performed by the learner L. It should be noted that, in order to grasp the progress of the work, the stereoscopic video generation unit 160 may utilize the status or the measured value obtained from the real measuring machine RM, through the measuring machine control unit 130, in addition to the position and the attitude of the learner L or the real measuring machine RM. The stereoscopic video generation unit 160 then causes the display unit 210 of the head-mounted display 200 to display the three-dimensional video of the exemplary work so as to precede the learner L's work by a predetermined time, based on the grasped progress of the work and the learning data. In other words, the stereoscopic video generation unit 160 checks that the learner L is tracing the exemplary work performed by the avatar AV, and simultaneously displays the appearance of the work to be performed next by the learner L, as the exemplary work performed by the avatar AV within the virtual three-dimensional space.

According to such a configuration, the motion of the avatar AV is automatically adjusted in accordance with a working speed of the learner L. The learner L can perform the work, following the avatar AV's operations, to thereby mimic the expert's work and perform his/her work. For the learner L wearing the head-mounted display 200, the virtual measuring machine AM operated by the avatar AV appears to overlap the real measuring machine RM operated by the learner L himself. The avatar AV thus appears to overlap the learner L himself, and the learner L wearing the head-mounted display 200 can observe the appearance of the exemplary work displayed so as to slightly precede the learner L's own work, at the same viewpoint as the avatar AV.

Moreover, the stereoscopic video generation unit 160 calculates delay (a delay time) of the grasped progress of the work from the exemplary work, and notifies the learner L of the delay time. Methods of the notification may include the notification displayed on the display unit 210 of the head-mounted display 200, the notification provided through the speech from the speaker 240, and the like.

Moreover, similar to the first learning mode, the learner L can give the orders to stop, repeat, slow down, rewind and the like, through the gesture or the operation of the input device. The stereoscopic video generation unit 160 receives these orders through the operation input unit 140 or the position and attitude recognition unit 150, and reflects the orders in the three-dimensional video data to be subsequently generated. Since such operations are enabled, the learner L can repeatedly practice the work over and over again.

In the second learning mode, the learner L can operate the real measuring machine RM for training, following the expert's exemplary work replicated by the avatar AV within the virtual space. The exemplary work is then played automatically in accordance with a level of the learner L. For example, the avatar AV performs a slightly further operation than that of the learner L, in response to the progress of the learner L's work. The learner L can thus be expected to naturally improve himself in the work. As a result, the learner L can be expected to rapidly master the work. Moreover, the learner L can view the knack or the know-how of the work for each measurement operation, listen to the messages, and thus easily understand the work. Accordingly, the efficient learning support is enabled.

According to such a configuration, the delay from the exemplary work can be grasped, and thus the learner L can easily grasp his/her own proficiency in comparison with the expert. Moreover, the learner L can grasp a process that the learner L is not good at, recognize a difference from a target working time, and also try to shorten a measurement time.

As described above, according to the learning support system 1 according to each embodiment of the present invention, since the virtual human model (avatar) replicates the expert's exemplary work, the learner L can repeatedly observe the appearance of the expert's exemplary work from the various angles. Moreover, a beginner can overlap the avatar to try after the avatar's motion of performing the slightly further operation. Moreover, a speed of the exemplary operation can be automatically adjusted in accordance with the learner's operating speed. Moreover, the learner can repeatedly perform self-education to learn in each learning mode, and can thus be supported to master the operation to a level close to an efficient operation in the exemplary work, in a short time.

It should be noted that while the present embodiment has been described above, the present invention is not limited to these examples. For example, in the second learning mode in the above described embodiment, after the learning data is started to play, the stereoscopic video generation unit 160 continually grasps the progress of the work performed by the learner L, and causes the display unit 210 of the head-mounted display 200 to display the three-dimensional video of the exemplary work so as to slightly precede the learner's work. The stereoscopic video generation unit 160 may, however, configure the exemplary work to be played at an ideal speed (for example, the expert's working speed) to a predetermined time point (or to the end of the work).

In this case, the stereoscopic video generation unit 160 may contrast the learning data being played, with the position or the attitude of the learner or the real measuring machine RM outputted by the position and attitude recognition unit 150 based on the position coordinates of the object obtained by the 3D sensor 300, and may thereby grasp the progress of the work performed by the learner L. Then, the delay (the delay time) of the work performed by the learner L from the exemplary work is calculated, and the learner L is notified of the delay time. The methods of the notification may include the notification displayed on the display unit 210 of the head-mounted display 200, the notification provided through the speech from the speaker 240, and the like.

Moreover, in the above described embodiment, the head-mounted display 200 includes the transmissive displays as the display unit 210, which may, however, be non-transmissive displays. If the non-transmissive displays are used, the head-mounted display 200 includes a camera that takes images in an eye gaze direction of the learner L (in front of the head-mounted display 200) in the real three-dimensional space. A video of the real three-dimensional space imaged by the camera and the three-dimensional video generated by the stereoscopic video generation unit 160 may be displayed on the non-transmissive displays in a superimposed manner.

In addition, the previously mentioned embodiment with addition, deletion or design change of any component made as appropriate by those skilled in the art, and also an appropriate combination of features of the embodiment fall within the scope of the present invention, as long as they have the spirit of the present invention.

What is claimed is:

1. A learning support system that supports learning of work using a real measuring machine for measuring a measurement object, comprising:
a position and attitude recognition unit that recognizes a position and/or an attitude of an object within a real three-dimensional space;
a storage unit that stores learning data that defines exemplary work performed by an avatar using a virtual measuring machine within a virtual three-dimensional space;
a stereoscopic video generation unit that generates a three-dimensional video of the exemplary work performed by the avatar, based on the position and/or the attitude of the object recognized by the position and attitude recognition unit, as well as the learning data stored in the storage unit; and
a head-mounted display that is mounted on a learner's head, and displays the three-dimensional video so as to be superimposed on the real three-dimensional space.

2. The learning support system according to claim 1, wherein
the position and attitude recognition unit recognizes the position and/or the attitude of the object within the real three-dimensional space, based on output from a three-dimensional sensor that detects three-dimensional coordinates of the object in the real three-dimensional space, and/or from a head sensor that is included in the head-mounted display and senses a position and/or an attitude of the head-mounted display.

3. The learning support system according to claim 1, wherein
the stereoscopic video generation unit recognizes a correspondence relationship between a coordinate system in the real three-dimensional space and a coordinate system in the virtual three-dimensional space, and generates three-dimensional video data so that a visual field moves within the virtual three-dimensional space in accordance with movement of the head-mounted display in the real three-dimensional space.

4. The learning support system according to claim 1, wherein the stereoscopic video generation unit performs:
placing the avatar at position coordinates within the virtual three-dimensional space corresponding to position coordinates where the head-mounted display exists in the real three-dimensional space;
placing the virtual measuring machine at position coordinates within the virtual three-dimensional space corresponding to position coordinates where the real measuring machine is placed in the real three-dimensional space;
grasping progress of the work performed by the learner, based on the learning data, as well as a position and an attitude of the learner and/or the real measuring machine outputted by the position and attitude recognition unit; and
generating the three-dimensional video data of the exemplary work so as to precede the learner's work by a predetermined time, based on the grasped progress of the work and the learning data.

5. The learning support system according to claim 1, wherein
the stereoscopic video generation unit calculates a delay time of the grasped progress of the work from the exemplary work, and notifies the learner of the delay time.

6. The learning support system according to claim 1, wherein
the stereoscopic video generation unit generates the three-dimensional video data so that the visual field moves within the virtual three-dimensional space in response to an operation without movement of the learner within the real three-dimensional space.

7. The learning support system according to claim 1, wherein
the head-mounted display comprises a transmissive display.

8. A non-transitory computer-readable recording medium storing a program, wherein the program causes a computer to function as a learning support system according to claim 1.
